(19) United States
(12) Patent Application Publication
(10) Pub. No.: US 2002/0132549 A1
(43) Pub. Date: Sep. 19, 2002

(54) Monitor opening saw

(76) Inventor: Harry Braunstein, Palm Harbor, FL (US)

Correspondence Address: BUCHANAN INGERSOLL, P.C., ONE OXFORD CENTRE, 301 GRANT STREET, 20TH FLOOR, PITTSBURGH, PA, 15219, US

(21) Appl. No.: 10/063,038

(22) Filed: Mar. 13, 2002

Related U.S. Application Data
(60) Provisional application No. 60/275,369, filed on Mar. 13, 2001.

(51) Int. Cl. H01J 9/52

(52) U.S. Cl. 445/2; 445/61

(57) ABSTRACT

Disclosed are an apparatus for and an automated method of recycling cathode-ray tubes. The apparatus comprise a PLC unit that controls a robotic arm, sensors, and a cutting saw. The robotic arm places a used cathode-ray tube device face down, on a platform, which includes a saw designed to cut the bezel off the monitor. The saw cuts the bezel to a depth determined by the PLC unit that receives the dimensions of the monitor as sensed by the sensors. The saw also makes additional cuts at each corner of the face of the cathode-ray tube to remove tabs that are holding the cathode-ray tube to the monitor. Once the tabs are cut and the bezel removed, the cathode-ray tube falls out easily.

### RELATED APPLICATIONS

### REFERENCED-APPLICATIONS

This application claims the benefit of U.S. Provisional Application Serial No. 60/275,369, filed Mar. 13, 2001.

### FIELD OF THE INVENTION

The present invention relates to an apparatus for and method of recycling cathode-ray tubes (CRT) from used devices, such as computer monitors, televisions, and the like. In particular, this invention enables a computer-aided system for removing a CRT from its enclosure. In its more particular embodiments, the present invention specifically pertains to a computer controlled robotic arm and power saw to cut an enclosure, preferably a computer monitor, housing a CRT away from such CRT.

### BACKGROUND OF THE PRIOR ART

Typically, a cathode-ray tube (CRT) is collected for recycling by a complex procedure requiring destruction of a used device housing containing the CRT, to separate the device housing from the CRT, and then extracting the CRT from the housing. It is important to recycle the glass from a CRT because it contains lead, used as shielding, which cannot be disposed in conventional landfills due to its toxicity. A few methods and apparatus have been developed to collect CRTs and their glass and metal components. For example, one method involves collecting CRTs by cutting the rear side of a used CRT monitor. The process includes mounting the monitor on a moveable platform. Suction cups, responsive to output signals, secure the rear side of the monitor to the platform. A video camera senses the dimensions of the rear side of the monitor and signals the dimensions to a computer. The computer signals the dimensions to the suction cups to control the position of the monitor to be cut. The computer signals the dimensions to a cabinet cutter that cuts the rear side accordingly.

However, the process suffers from various problems. The process does not teach how the computer calculates the dimensions of the monitor based on the video image or which dimensions are calculated. Additionally, the process does not teach how the position of the monitor is adjusted relative to the cabinet cutter. Furthermore, the process does not teach how the computer determines locations and depths of cuts in the rear side. Moreover, cutting the rear side of the cabinet does not release the CRT from the housing.

Other methods include manual extraction of a CRT from a monitor to disassemble its components. For example, U.S. Pat. No. 6,089,937 discloses a method for extracting the components of a CRT. The method includes wrapping electrical heating wires around the face of a CRT and supplying heating power to the wires until the face separates from the funnel portion. Tensional force may also be applied to the electrical heating wires using springs. A similar process is disclosed in U.S. Pat. No. 6,089,433 with a preliminary step of scratching corner portions of the face of a CRT, and applying electrical heating wires along the scratch lines.

Typically, manual extraction of a CRT involves separating the enclosure housing the CRT by either removing fasteners holding the enclosure together or by cutting the back of the enclosure. Fasteners that connect the CRT to the bezel (the sloping frame around the face of the CRT) are manually removed and the bezel taken away. Any wires that connect the CRT to the monitor are cut to lift the CRT from the remains of the enclosure. However, the process is time and energy consuming and impractical for large numbers of monitors.

Consequently, in light of the problems discussed above, and other problems associated with presently available CRT recycling methods and apparatuses, there exists an unfulfilled need for an automatic process for extracting CRTs from their enclosures, a process that teaches where and how deep to cut the enclosure to extract the CRT without destroying its glass.

### SUMMARY OF THE INVENTION

An object of the invention is to enable an automated apparatus for collecting CRTs from used devices on a mass scale basis.

Another object of the invention is to provide an automated apparatus for cutting used CRT enclosures to facilitate extracting CRTs.

Another object of the invention is to provide for an automated apparatus able to cut all sizes of CRT enclosures.

Another object of the invention is to enable an automated apparatus that senses the dimensions of such enclosures in preparation for cutting. A related object of the invention is to enable an automated apparatus that locates the outside edge of such enclosures. A further related object of the invention is to enable an automated apparatus that locates the inside edge of a cathode-ray tube enclosure where the bezel edge meets the CRT face.

Another object of the invention is to enable a cutting apparatus that senses the dimensions of a CRT enclosure, for use in determining where to cut the CRT enclosure. A related object of the invention is to enable an automated method of cutting a large number of CRT enclosures.

A further object is to positionally-interrelate multiple components, which act cooperatively for positioning a CRT enclosure for cutting.

The above-listed objects are met or exceeded by the present apparatus for and method of recycling CRTs. The present invention provides for an apparatus that comprises a robotic arm, sensors, and cutting saw. The sensor senses the dimensions of a CRT enclosure, sends such dimensions to a computer unit that adjusts the cutting saw according to such sensed dimensions and positions the CRT enclosure in relation to the saw to precisely cut away the CRT enclosure without cutting the CRT glass.

By decreasing difficulties in automatically removing a CRT from its enclosure, recycling operation of such CRT can be carried out more quickly and economically. Obstacles to automatic CRT removal are further removed by eliminating concern about potential damage to the CRT during removal.

### BRIEF DESCRIPTION OF THE DRAWINGS

The above and other features, aspects, and advantages of the present invention are considered in more detail, in relation to the following description of embodiments thereof shown in the accompanying drawings, in which:

FIG. 1 shows front and side elevational views of a CRT enclosure;

FIG. 2 is a perspective view of a CRT;

FIG. 3 is a general arrangement plan view of one embodiment of the invention;

FIG. 4 is a front elevational view of the embodiment of FIG. 3, for describing operational features of the invention;

FIG. 5 is a side elevational view of the embodiment of FIG. 3, for describing operational features of the invention; and

FIG. 6 is a front elevational view of a CRT and enclosure, for describing features of the invention.

### DETAILED DESCRIPTION OF THE INVENTION

The invention summarized above and defined by the enumerated claims may be better understood by referring to the following detailed description, which should be read in conjunction with the accompanying drawings in which like reference numbers are used for like parts. This detailed description of an embodiment, set out below to enable one to build and use an implementation of the invention, is not intended to limit the enumerated claims, but to serve as a particular example thereof. Those skilled in the art should appreciate that they may readily use the conception and specific embodiment disclosed as a basis for modifying or designing other methods and systems for carrying out the same purposes of the present invention. Those skilled in the art should also realize that such equivalent assemblies do not depart from the spirit and scope of the invention in its broadest form.

Referring to a specific embodiment, an enclosure containing a CRT is placed, face down, on a platform, which includes a saw designed to cut the bezel off the enclosure. The saw cuts the bezel to a depth determined by a computer unit, after receiving dimensions of the bezel as sensed by sensors included on the platform. The saw also makes additional cuts at each corner of the face of the CRT to remove couplings (tabs) holding the CRT in the enclosure. With the tabs cut and the bezel removed, the CRT can be easily removed from the enclosure.

In a preferred embodiment, the saw cuts along the full length of the four sides of the bezel approximately one-half inch from the bezel edge measured from where the bezel meets the CRT glass. In the majority of cases, it was discovered that cutting the bezel at a location between 0.50 to 0.90 inch, measured from the edge of the bezel adjacent to the CRT glass, separates the CRT from the enclosure without touching the glass. In addition, it was discovered that, in the majority of cases, a 45-degree cut that crosses the intersection of the vertical and horizontal cuts severs the tabs holding the CRT to the enclosure thereby releasing the CRT from the bezel.

In a preferred embodiment, a control system is included to automatically determine the dimensions of the enclosure, position the enclosure on the platform, and control the saw to cut the enclosure according to the dimensions of the enclosure as determined by the control system. A means for positioning the enclosure on the platform may include a robotic arm apparatus, or similar device.

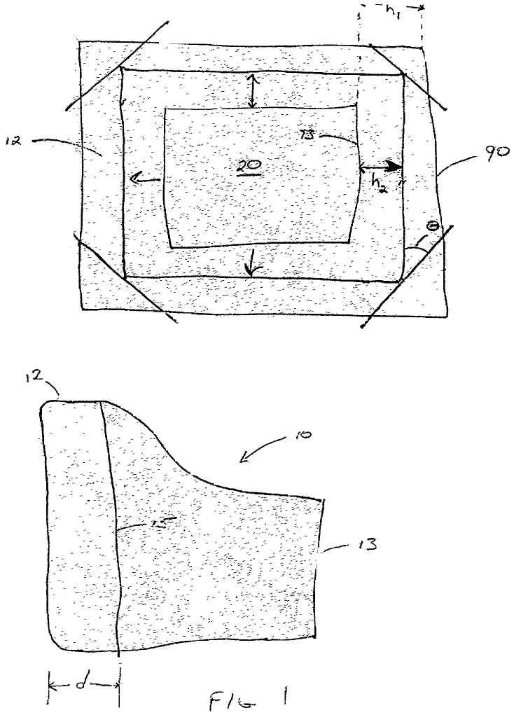

Referring to the drawings, FIG. 1 presents an illustration of a CRT enclosure 10 having a bezel 12 and casing 13 joined at seam 15. Enclosure 10 may be of various shapes, sizes and types commercially available in such structures as computer monitors, televisions, and the like.

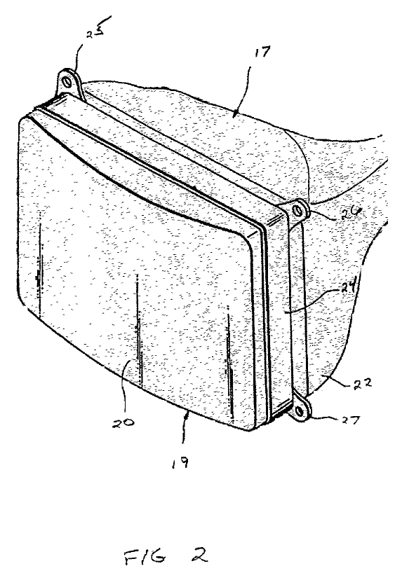

In FIG. 2, a cathode-ray tube (CRT), generally denoted at reference numeral 17, comprises a front portion 19, having a glass screen 20, and a funnel portion 22 which are fastened together by welding of a flit glass (solder glass). An anti-explosion band 24 is attached to the periphery of the front portion 19 adjacent to glass screen 20. Tabs 25, 26, 27, and 28 (tab 28 is not shown) are attached to the anti-explosion band at the corners of the front portion 1 9 adjacent to glass screen 20. Tab 28 is located at the unexposed corner of CRT 17, below tab 25 and across from tab 27. CRT 17 is attached to enclosure 10 by attachment means, such as fasteners through the middle of tabs 25, 26, 27, and 28 (tab 28 is not shown) attached to anti-explosion band 24.

A function of a preferred embodiment of the invention presented herein, is to cut bezel 12 (FIG. 1) and tabs 25, 26, 27, 28 (FIG. 2) to remove CRT 17 from enclosure 10.

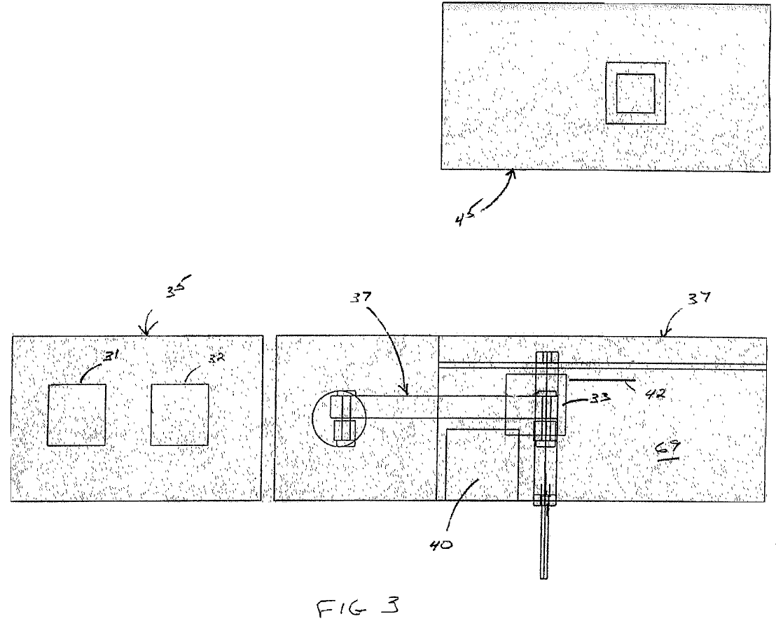

In FIGS. 3-5 there is presented a system overview of an exemplary embodiment of the present invention. In the specific embodiment of FIG. 3, interactive components of the invention are in a fixed location while enclosures 31, 32, 33 move into, and from, such fixed location during CRT removal. Supply conveyor 35 transports enclosures 31, 32 to the CRT removal apparatus disclosed by the present invention. A robot arm, generally indicated as 37, lifts a CRT enclosure from supply conveyor 35 and places it face-down on table 39 in a position such that dimension sensing means 40 can determine the size of the enclosure bezel 12 and the dimensional relationship with the CRT glass screen 20. Robot arm 37 then positions the CRT enclosure, such as 33, to be cut by a cutting means such as circular saw blade 42. The cutting means may be a band saw, a circular saw, or any other cutting device known in the art. Following a cutting operation, robot arm 37 can transfer the CRT and enclosure for further processing to, for example, exit conveyor 45.

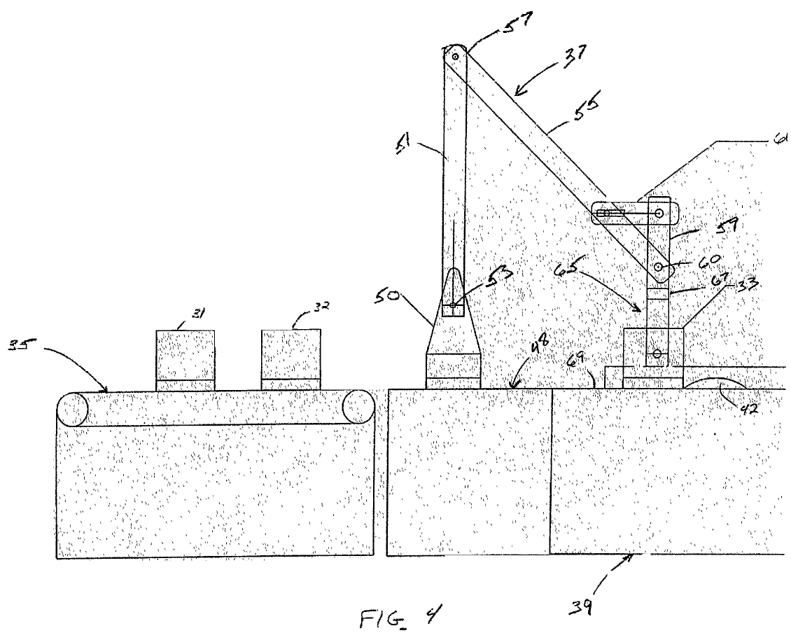

Referring to FIG. 4, robot arm 37 is rotatably mounted to support structure 48 by rotatable base 50, which allows 360° of rotation about a vertical axis. An upright bar 51 is pivotally attached to rotatable base 50 at pivot point 53, which enables flexion of upright bar 51 up to 90° from vertical in either direction. Extension arm 55 is pivotally attached at one end to upright bar 51 at elbow 57, which allows rotation up to 135° about its transverse axis. Extension arm 55 is pivotally attached at its remaining end to clamp support 59 at joint 60. Leveler 61, disposed between clamp support 59 and extension arm 55 provides stability to a rotatable clamp, generally indicated as 65. Wrist 67 at the lower end of clamp support 59 allows 360° of rotation of rotatable clamp 65 about a vertical axis.

Other positioning systems known in the art may be used. For example, a laterally oriented x-y positioner including means for raising and lowering an enclosure may be included in place of such robot arm described above.

The thickness of the severing portion of blade 42 is predetermined and correlated, enabling at least a portion of its cutting edge to fit through an open slot in the upper surface 69 of table 39, and of sufficient strength and thickness to cut metal tabs 25, 26, 27, and 28 (tab 28 is not shown). In a preferred embodiment, blade 42 presents a large diameter circular configuration saw blade including a plurality of peripherally located teeth. Blade 42 is preferably manufactured of high-grade material such as a tungsten-carbide or carbide tip cutting wheel including a large number of blade teeth throughout its entire peripheral circumference.

In the specific embodiment of FIG. 4, blade 42 is vertically oriented and substantially perpendicular to a horizontally oriented support plane defined by upper surface 69 of table 39.

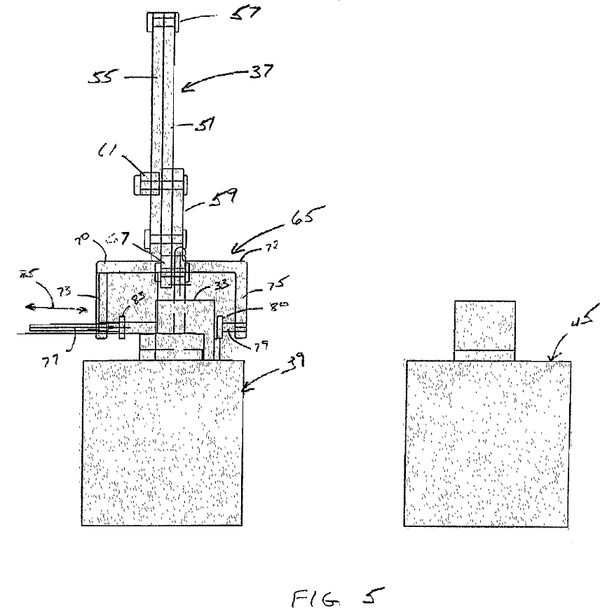

Rotatable clamp 65, as shown in FIG. 5, comprises horizontal wings 70, 72 rigidly attached to and supported by wrist 67. The wings extend into vertical fixed arm structures 73, 75, which are detachably joined to clamping pad extensions 77, 79 at their distal end. At least one of such clamping pad extension 77, 79 is joined to its respective vertical fixed arm structure so as to allow such clamping pad extension to be variably positioned to enable rotatable clamp 65 to grab and hold an enclosure such as 33.

In the illustrated embodiment, clamping pad extension 79 is fixedly attached to vertical fixed arm 75 and terminates in clamping pad 80. Clamping pad extension 77 is joined to vertical fixed arm 73 in such a manner to enable clamping pad 83 to be moved toward or away from enclosure 33 as indicated by arrow 85.

The embodiment of FIGS. 3-5 accommodates a variety of sizes and shapes of CRT enclosures 10. Strength requirements and acceptable component spacing are determined by construction requirements. Saw tooling and support structures are readily adapted to such enclosure shape and size.

In practice, control of the robotic arm 37, rotatable clamp 65, and the blade 42 is accomplished by a programmable logic controller (PLC), which is calibrated to a known position of clamp 65 with reference to the location of blade 42 and a normalized reference position. In particular, the PLC orients and positions robotic arm 37, which transports enclosure 33 and delivers it to blade 42. Robotic arm 37 and rotatable clamp 65 provide horizontal motion of an enclosure such as 31, 32, and 33 from entry conveyor 35 to blade 42. The robotic arm 37, which holds the enclosure by mechanical, pneumatic or other means known in the art, moves the enclosure from entry conveyor 35 to dimension sensing means 40 on table 39. Robotic arm 37 grasps a CRT enclosure with rotatable clamp 65 and moves such enclosure to a position on top surface 69 of table 39 such that enclosure 33, held by rotary clamp 65, is positioned over dimension sensing means 40 with the glass screen 20, on top of surface 69.

Table 39 supports dimension sensing means 40, which may comprise an optical scanning assembly, a mechanical sensor, a magnetic sensor, or other means known in the art. For example, in operation, a mechanical sensor first locates an outside edge 90, shown in FIG. 1, of bezel 12, the sensor then moves across the front of bezel 12 to locate a corresponding inside edge 93 of bezel 12 where such bezel 12 meets the glass screen 20 of CRT 17. Such mechanical sensors may include walking fingers that travel across the face of the CRT enclosure to measure its dimensions. Optical sensors well known in the art may also be used. For example, an optical sensor directs a beam of light at a surface of the CRT enclosure, and a photodetector element detects a reflected portion of the beam. The PLC unit determines a particular dimension of the CRT enclosure by measuring the distance by which the reflected light signal is offset from a predetermined point on the photodetector, which is aligned with a reference plane at the CRT enclosure. Such optical sensor is disclosed in U.S. Pat. No. 4,375,921, which is incorporated herein by reference.

In one embodiment, the PLC, through dimension sensing means 40, measures the width of bezel 12, indicated in FIG. 6 as h₁, and calculates the position of a predetermined offset h₂ on the front of bezel 12. A value for h₂ between about 0.50 inches to about 0.90 inches, measured from the inside edge 93 of bezel 12 adjacent to glass screen 20, has been determined to be sufficient to separate the CRT 17 from the enclosure 10 without damaging the glass. The width h₁ of bezel 12 is not critical. Offset h₂ is selected as a sufficient distance away from inside edge 93 such that a cut parallel to edge 93 along the full length of outside edge 90 will not damage CRT 17.

The PLC, through dimension sensing means 40, also measures the depth of bezel 12, indicated in FIG. 1 as d, for example, by locating the seam 15 (FIG. 1). Such width measurement, offset, and depth is determined for all sides of enclosure 33. Other dimensions of enclosure 10 can also be measured, such as the base and height measurements, which would indicate how long the cuts should be made. In an alternate embodiment, the system could make all cuts the same length, for example 24-inches or 36-inches, to include all varieties of enclosures.

The orientation of rotatable clamp 65 is known for a predetermined normalized position, and thereby the precise location of offset h₂ is determined. In order to cut the bezel 12 without damage to CRT 17, the enclosure must be delivered at a certain orientation to blade 42. Hence, the PLC determines the width and depth correction needed to position rotatable clamp 65 and robotic arm 37 so that enclosure 33 can be delivered to blade 42 properly oriented. In addition, the PLC positions blade 42, up or down, if needed to make proper cuts to the depth d (FIG. 1) of bezel 12.

The PLC signals the robotic arm 37 and rotatable clamp 65 to accurately orient and position enclosure 33 for delivery to blade 42 in precise alignment, and to guide enclosure 33 as it is cut. The PLC also signals the robotic arm 37 and rotatable clamp 65 to rotate enclosure 33 about wrist 67 to cut all sides of such enclosure.

Following cutting of all sides of bezel 12, the PLC repositions enclosure 33, with respect to blade 42 to cut tabs 25, 26, 27, and 28, (tab 28 is not shown). The PLC determines an offset angle Θ, shown in FIG. 6, measured from an imaginary point at the intersection of two perpendicular lines of cut in bezel 12 with respect to one such cut line. The angle Θ, preferably 45°, is selected as a sufficient orientation to sever the tabs off anti-explosion strap 24 without damage to CRT 17 while detaching such CRT 17 from enclosure 10. The PLC signals the robotic arm 37 and rotatable clamp 65 to accurately orient and position each tab 25, 26, 27, and 28, (tab 28 is not shown), for delivery to blade 42 in precise alignment, and to guide enclosure 33 as each tab is cut. The PLC also signals the robotic arm 37 and rotatable clamp 65 to rotate enclosure 33 about wrist 67 to cut all tabs of such enclosure.

After cutting bezel 12 and tabs 25, 26, 27, and 28, (tab 28 is not shown), enclosure 33 is lifted by robotic arm 37 so that an operator can cut any wires connecting enclosure 33 and CRT 17. Enclosure 33 is then deposited on exit conveyor 45 while CRT 17 is left on table 39 for further processing

In an alternate embodiment, sensing means 40 comprises a magnetic sensor. Magnetic sensors are well known in the art. A magnetic sensor is typically composed of different layers of magnetic films having certain magnetic direction. The magnetic films change their direction in accordance with an external magnetic field. Ferromagnetic metals, such as steel or the like used in making tabs 25, 26, 27, and 28, (tab 28 is not shown), produce an external magnetic field that induces changes in the magnetization direction of the magnetic films, which changes the value of a current flowing through the magnetic sensor. The change in the value of a current enables the sensor to locate the tabs.

Once the magnetic sensor locates tabs 25, 26, 27, and 28 (tab 28 is not shown), it sends the location information to the PLC. The PLC directs the robotic arm 37 and rotatable clamp 65 to deliver enclosure such as 31, 32, and 33 to blade 42. Blade 42 cuts tabs 25, 26, 27, and 28 in a 45° angle. The magnetic sensor calculates the position of a predetermined offset h₂ on bezel 12. A value for h₂ between about 0.50 inches to about 0.90 inches, measured from the inside edge 93 of the bezel adjacent to glass screen 20, has been determined to be sufficient to separate the CRT from the enclosure without damaging the glass. Offset h₂ is selected as sufficient distance away from the inside edge 93 such that a cut parallel to edge 93 along the full length of outside edge 90 will not damage CRT 17.

The PLC directs the robotic arm 37 and rotatable clamp 65 to orient enclosure 33 for delivery to blade 42. Blade 42 makes cuts in the four sides of bezel 12 parallel to edge 93 along the length of outside edge 90.

After cutting the bezel and the tabs, enclosure 33 can be delivered to exit conveyor 45 for further processing.

While specific values, relationships, materials and steps have been set forth for purpose of describing concepts of the invention, it should be recognized that, in the light of the above teachings, those skilled in the art can modify those specifics without departing from basic concepts and operating principles of the invention taught herein.

Therefore, for purposes of determining the scope of patent protection, reference shall be made to the appended claims in combination with the above detailed description.

1. An apparatus for separating a cathode ray tube from an enclosure having one or more attachment members connecting the cathode ray tube to the enclosure, comprising:
a cutting member;
a sensor, said sensor being capable of determining where to cut with said cutting member so as to sever said attachment member without cutting said cathode ray tube;

2. The apparatus of claim 1 further comprising a robotic component for positioning said enclosure in a functional relation to said cutting member.

3. The apparatus of claim 1, wherein said cutting member is selected from the group consisting of a band saw, a table saw, a circular saw and a planar saw.

4. The apparatus of claim 1, wherein said cutting member is adjustable to make cuts of variable depth.

5. The apparatus of claim 1, wherein said sensor can sense at least one dimension of said enclosure.

6. The apparatus claim 5, wherein said sensor is selected from the group consisting of mechanical sensors, optical sensors and magnetic sensors.

7. The apparatus of claim 2, wherein said robotic component comprises a robotic arm having a clamp connected to one end thereof.

8. The apparatus of claim 5 wherein:
said enclosure has a front bezel portion adjacent said exposed glass screen of said cathode ray tube; and
said sensor establishes one or more locations to cut said front bezel portion so as to sever said one or more attachment members without cutting said cathode ray tube according to said at least one dimension of said enclosure.

9. A method for separating a cathode ray tube having a glass screen from an enclosure having a front bezel portion with an edge adjacent to said glass screen and having one or more attachment members connecting said cathode ray tube to said front bezel portion comprising the steps of:
providing a cutting component;
determining one or more locations to cut said enclosure so as to sever said one or more attachment members without cutting said cathode ray tube;
positioning said enclosure in a functional relation with said cutting member; and
cutting said front bezel portion of said enclosure according to said one or more locations.

10. The method of claim 9, wherein said step of determining said one or more locations to cut said enclosure further comprises:
calculating the position of a predetermined offset measured from said edge of said front bezel adjacent to said exposed glass screen of said cathode ray tube, said offset being measured away from said glass screen, such that one or more cuts substantially parallel to said edge of said front bezel will not damage said cathode ray tube.

11. The apparatus of claim 2, further comprising a processor for automatically controlling said cutting member and said robotic component, based on readings from said sensor.

12. A method of separating a cathode ray tube having a glass screen from an enclosure having a front bezel portion with an edge adjacent to and meeting said glass screen and having one or more attachment members connecting said cathode ray tube to said front bezel portion comprising the steps of:
providing a cutting member;
sensing one or more dimensions of said enclosure; providing a processor;
determining one or more locations to make cuts in said enclosure so as to sever said one or more attachment members without cutting the cathode ray tube, said determination being made based on said one or more sensed dimensions read by said processor;
positioning said enclosure using a robotic component in a functional relation with said cutting member, based on said on or more determined locations; and
cutting said front bezel portion of said enclosure according to said one or more determined locations.

13. The method of claim 12, wherein said processor calculates an offset measured from said edge of said front bezel adjacent said exposed glass screen of said cathode ray tube, said offset being measured away from said glass screen, such that one or more cuts substantially parallel to said edge of said front bezel will not damage said cathode ray tube.

14. An apparatus for separating a cathode ray tube having an exposed glass screen from an enclosure having one or more attachment members connecting said cathode ray tube to said enclosure and a front bezel portion with an edge adjacent to said exposed glass screen of said cathode ray tube, comprising:
a cutting member;
a robotic component capable of positioning said enclosure with respect to said cutting member; and
a processor for controlling said cutting member and said robotic component.

15. The apparatus of claim 14 wherein said processor:
reads a sensor to ascertain at least one dimension of said front bezel portion;
calculates one or more offset locations, measured from said edge of said front bezel adjacent said exposed glass screen of said cathode ray tube, said one or more offset locations being measured away from said glass screen;
signals said robotic component to position said enclosure in a functional relation with said cutting member, according to said one or more offset locations; and
signaling said cutting member to cut said enclosure at said one or more offset locations such as to sever said one or more attachment members without cutting said cathode ray tube.

16. A method for separating a cathode ray tube having a glass screen from an enclosure having a front bezel portion with an edge adjacent to and meeting said glass screen, comprising the steps of:
sensing at least one dimension of said front bezel portion of said enclosure;
calculating one or more locations making one or more cuts in said enclosure; calculating a preferred depth of said one or more cuts; and controlling a cutting member based on said calculated one or more locations and depth to make said one or more cuts in said enclosure.

17. An apparatus for separating a cathode ray tube having an exposed glass screen from an enclosure having one or more attachment members connecting said cathode ray tube to said enclosure and a front-bezel portion with an edge adjacent to said exposed glass screen of said cathode ray tube, comprising:
one or more sensors for sensing one or more dimensions of said enclosure;
a processor for reading said one or more sensors and calculating the location of one or more cuts to separate said enclosure from said cathode ray tube, said calculated one or more locations based on said readings from said one or more sensors; and
a cutting member for making said one or more cuts in said enclosure, controlled by said processor.

18. The apparatus of claim 17, further comprising:
a robotic component capable of positioning said enclosure to enable said one or more sensors to sense the dimensions of said enclosure and to enable said cutting member to make said one or more cuts in said enclosure.

19. The apparatus of claim 17, wherein said one or more sensors are selected from the group consisting of mechanical sensors, optical sensors, and magnetic sensors.

20. The apparatus of claim 18, wherein said robotic component comprises a robotic arm having a clamp for holding said enclosure.

21. The apparatus of claim 17, wherein said cutting member is selected from the group consisting of a band saw, table saw, circular saw, and a planar saw.

22. 1.An apparatus for separating a cathode ray tube having an exposed glass screen from an enclosure having one or more attachment members connecting said cathode ray tube to said enclosure and a front bezel portion with an edge adjacent to said exposed glass screen, comprising:
at least one sensor for sensing the dimensions of said enclosure;
at least one processor for reading said dimensions from said at least one sensor and processing said dimensions to obtain one or more preferred locations to cut said enclosure; and
at least one cutting member, controlled by said processor, to make one or more cuts in said enclosure.

23. The apparatus of claim 22, wherein said at least one processor processes said sensed dimensions and further wherein said at least one processor calculates the position of a predetermined offset measured from said edge of said front bezel adjacent to said exposed glass screen, such that one or more cuts substantially parallel to said edge of said front bezel will not damage said cathode ray tube.

24. The apparatus of claim 22, further comprising at least one robotic arm for transporting said enclosure across said at least one sensor and positioning said enclosure with respect to said at least one cutting member.

25. An apparatus for cutting a portion of a cathode ray tube enclosure to separate said cathode ray tube from said enclosure, said enclosure having a front bezel enclosing said cathode ray tube, wherein the cathode ray tube is connected to the front bezel through a plurality of couplings, comprising:
a remotely operable cutting device for making cuts in said bezel, wherein said cutting device makes two parallel horizontal cuts and two parallel vertical cuts in said bezel, wherein each cut is approximately 0.5 to 0.9 inches from an edge of said bezel and wherein said cutting device cuts said plurality of couplings, whereby said cathode ray tube is separated from said enclosure.

26. A method for separating a cathode ray tube coupled to an enclosure by one or more attachment members from said enclosure comprising the steps of:
reading a sensor to ascertain at least one dimension of the said enclosure;
calculating one or more locations to cut said enclosure; signaling a robotic component to position said enclosure in a functional relation with a cutting member, according to said calculated location; and
signaling said cutting member to cut said enclosure at said calculated one or more locations such as to sever said one or more attachment members without cutting said cathode ray tube.

27. The apparatus of claim 11, wherein said processor is a programmable logic controller.

28. The apparatus of claim 12, wherein said processor is a programmable logic controller.

29. The apparatus of claim 14, wherein said processor is a programmable logic controller.
